(19) United States
(12) Patent Application Publication
(10) Pub. No.: US 2004/0222598 A1
(43) Pub. Date: Nov. 11, 2004

(54) Pipe joint gasket with closed end face

(76) Inventor: James W. Skinner, Fort Wayne, IN (US)

Correspondence Address: BAKER & DANIELS, 111 E. WAYNE STREET, SUITE 800, FORT WAYNE, IN, 46802

(21) Appl. No.: 10/461,725

(22) Filed: Jun. 13, 2003

Related U.S. Application Data
(60) Provisional application No. 60/467,992, filed on May 5, 2003.

(51) Int. Cl. F16L 5/02

(52) U.S. Cl. 277/606

(57) ABSTRACT

A pipe joint gasket with a closed end face. An annular anchoring projection extends outwardly from the external surface of the gasket and is embedded within a structure with which the gasket is used. The gasket also includes a sealing projection for engaging a pipe to provide a compressive, fluid tight seal between the pipe and the gasket. In applications in which the gasket is used for a pipe joint, the closed end face of the gasket may be slit or removed to allow a pipe to pass through the gasket. Alternatively, in applications in which the gasket is not used for a pipe joint, the end face remains intact, and has a thickness sufficient to withstand internal pressures within the structure and external pressures from without the structure.

### CROSS REFERENCE TO RELATED APPLICATIONS

This application claims the benefit under Title 35, U.S.C. § 119(e) of U.S. Provisional Patent Application Serial No. 60/467,992, entitled PIPE JOINT SEAL WITH CLOSED END FACE, filed on May 5, 2003. (Attorney Ref. No. PSG0035).

### BACKGROUND OF THE INVENTION

1. Field of the Invention

The present invention relates to a gasket or seal for use in a pipe joint application, in which the gasket seals a connection between an opening in a structure and a pipe extending through the opening.

2. Description of the Related Art

In general, pipe joint gaskets or seals are well known in the art for sealing a pipe joint connection between a pipe and a structure in which the pipe is mounted. In one particular application, a pipe joint is formed between a sewer pipe and a concrete manhole riser, for example, in which a sewer pipe is inserted through a gasket embedded within the concrete wall of the manhole riser. In other applications, pipe joints may be provided to connect pipes to septic tanks, for example, or may be provided in any other structures to which pipes are connected.

Pipe joint gaskets are typically formed from an elastomeric material by molding, or alternatively, may be formed by extrusion, in which a length of extruded material is cut and the ends of the material are secured to one another in a suitable manner to form an annular shaped gasket. The gasket is mounted within an opening in a structure, typically by embedding a portion of the gasket in the structure when the structure is cast, or by using an expansion band to radially compress the gasket into engagement with the interior wall of an opening in the structure. When a pipe is inserted through the gasket opening, the outer surface of the pipe engages the gasket to provide a fluid tight seal between the pipe and the structure.

Specifically, some known gaskets are provided with an inwardly extending sealing portion, which resiliently engages the outer surface of the pipe in a wiping manner to form a fluid tight seal. A disadvantage with these types of gaskets is that irregularities in the gasket or in the pipe surface could result in an ineffective seal between the gasket and the pipe. Alternatively, separate clamping bands may be provided to clamp the gasket to the outer surface of the pipe to effect a fluid tight seal therebetween. Although clamping bands are effective, the use of clamping bands requires additional labor and also adds additional assembly steps to the installation of a pipe connection to a structure.

A structure such as a manhole riser or a septic tank may be provided with several openings, each fitted with a gasket. In many applications however, it is not known which openings and gaskets will be used for pipe joints until the structure is actually installed in the field. Any unused openings are usually closed by a separate cap which is fixed to the unused gasket of the opening to close same in a fluid tight manner. The caps must be able to withstand any internal pressures from within the structure, as well as external pressures from outside the structure. Problematically, closing unused openings of the structure with caps requires additional labor during the installation of the structure.

What is needed is a gasket for providing a fluid tight connection between a pipe and a structure, which is an improvement over the foregoing.

### SUMMARY OF THE INVENTION

The present invention provides a pipe joint gasket with a closed end face. An annular anchoring projection extends outwardly from the external surface of the gasket and is embedded within a structure with which the gasket is used. The gasket also includes a sealing projection for engaging a pipe to provide a compressive, fluid tight seal between the pipe and the gasket. In applications in which the gasket is used for a pipe joint, the closed end face of the gasket may be slit or removed to allow a pipe to pass through the gasket. Alternatively, in applications in which the gasket is not used for a pipe joint, the end face remains intact, and has a thickness sufficient to withstand internal pressures within the structure and external pressures from without the structure.

The gasket has a sealing projection integrally formed with the body portion of the gasket. The sealing projection is foldable about a hinge portion of the gasket between first and second stable positions. The sealing projection is disposed in its first stable position when the gasket is installed within the structure, wherein a material such as concrete is poured around forms and around the gasket and, when the concrete cures, the anchoring projection is embedded within the concrete to secure the gasket within an opening in the structure. The sealing projection is then separated from the material, if necessary, and folded inwardly to its second stable position. The end face of the gasket is slit or removed to allow a pipe to pass through the gasket. Thereafter, when the pipe is inserted through the gasket, the sealing projection is compressed between the pipe and the body of the gasket to form a fluid tight seal with the outer surface of the pipe.

Advantageously, in applications in which the gasket is not used for a pipe joint, the closed end face of the gasket remains intact, such that the need for a separate end cap for closing the gasket is eliminated. When the gasket is used for a pipe joint, the end face of the gasket may be easily slit or cut away from the remainder of the gasket to create and opening through which a pipe may pass through the gasket. A further advantage is that, because a fluid tight seal is formed by compression of the sealing projection of the gasket between the pipe and the body of the gasket, separate clamping bands are not required to provide a seal between the pipe and the gasket.

In one form thereof, the present invention provides a gasket, including an annular body having a first end, an opposite second end, an exterior surface, and an interior surface; a wall portion extending across and closing the first end of the annular body; an annular sealing projection connected to the second end of the body, the sealing projection movable between a first position in which the sealing projection extends outwardly from the body and a second position in which the sealing projection is disposed within the body and is compressible against the body.

In another form thereof, the present invention provides a gasket for providing a seal between a pipe and a circular opening in a structure, the gasket including an annular body having a first end, an opposite second end, an exterior surface, and an interior surface; means extending across the first end of the body for alternatively closing the first end of the body or providing an opening through the first end of the body; an annular sealing projection connected to the second end of the body, the sealing projection movable between a first position in which the sealing projection extends outwardly of the body and a second position in which the sealing projection is disposed within the body and adjacent the interior surface of the body; whereby the sealing projection in the second position is compressible against the annular body upon insertion of a pipe through the opening.

In another form thereof, the present invention provides, in combination, a structure having a wall with a circular opening therein; and a gasket installed within the opening, the gasket including an annular body having a first end, an opposite second end, an exterior surface, and an interior surface; a wall portion closing the first end of the annular body, the wall portion selectively penetrable to provide a pipe opening therethough; an annular sealing projection connected to the second end of the body, the sealing projection movable between a first position in which the sealing projection extends outwardly from the body and a second position in which the sealing projection is disposed within the body; whereby the sealing projection is compressible against the body in the second position upon insertion of a pipe through the pipe opening.

In a further form thereof, the present invention provides a method of providing a seal between a pipe and a structure, including the steps of installing a body of a gasket within an opening in the structure; cutting a closed face of the gasket to form an opening through the gasket; folding a sealing projection of the gasket from a first position in which the sealing projection extends substantially longitudinally away from the body of the gasket to a second position in which the sealing projection is disposed within the body of the gasket; and inserting a pipe through the opening to compress the sealing projection between the pipe and the body of the gasket.

### BRIEF DESCRIPTION OF THE DRAWINGS

The above-mentioned and other features and objects of this invention will become more apparent and the invention itself will be better understood by reference to the following description of an embodiment of the invention taken in conjunction with the accompanying drawings, wherein:

FIG. 1 is a partially sectioned perspective view of a pipe joint, including a pipe sealingly mounted in a concrete structure using a pipe joint gasket in accordance with the present invention;

FIG. 2 is a sectional view of the gasket of FIG. 1;

FIG. 3 is sectional view showing the manner in which the gasket is mounted within the structure, using forms positioned to confine the gasket and the concrete when casting the structure;

FIG. 4 is a perspective view of the gasket mounted within the structure, showing a portion of the sealing projection of the gasket being folded inwardly from its first stable position to its second stable position;

FIG. 5 is a perspective view of the gasket mounted within the structure with the sealing projection of the gasket folded inwardly to its second stable position, and further showing a pipe being inserted through the gasket; and

FIG. 6 is a sectional view of a portion of the gasket, showing the first stable position of the sealing projection in solid lines, and the second stable position of the sealing projection in dashed lines.

Corresponding reference characters indicate corresponding parts throughout the several views. Although the drawings represent an embodiment of the present invention, the drawings are not necessarily to scale and certain features may be exaggerated in order to better illustrate and explain the present invention. The exemplifications set out herein illustrate a preferred embodiment of the invention and such exemplifications are not to be construed as limiting the scope of the invention in any manner.

### DETAILED DESCRIPTION

Referring to FIG. 1, a pipe joint application is shown, including a concrete structure 10, such as a manhole riser, in which at least a portion of a gasket or seal 12 is embedded. Pipe 14 extends through gasket 12, and gasket 12 provides a fluid tight seal between pipe 14 and structure 10. Except as discussed below, the overall structure and function of gasket 12 is similar to the gasket which is described in U.S. Pat. No. 4,809,994, assigned to the assignee of the present invention, the disclosure of which is expressly incorporated herein by reference.

Although the pipe joint application shown in FIG. 1 and described below is between a pipe and a concrete structure such as a manhole riser, the present gasket may generally be used in any application in which a pipe is mounted to an opening within a structure. For example, the present gasket may also be used in a septic tank having a plurality of inlets to which one or more pipes are respectively connected. Also, although structure 10 is illustrated and described below as being formed from concrete, structure 10 may alternatively be formed from other suitable materials, such as iron, steel, or plastic, for example.

Concrete structure 10 is provided with opening 16 extending therethrough, in which gasket 12 and pipe 14 are received. Opening 16, and thus gasket 12 and pipe 14, may have any suitable diameter, depending on the particular application. Gasket 12 provides a fluid tight seal or joint between opening 16 and exterior surface 18 of pipe 14 and, as described below, gasket 12 is constructed such that the fluid tight joint between structure 10 and pipe 14 is maintained even if the diameter of pipe 14 varies slightly from the diameter of gasket 12, or if pipe 14 is angled as it extends through opening 16.

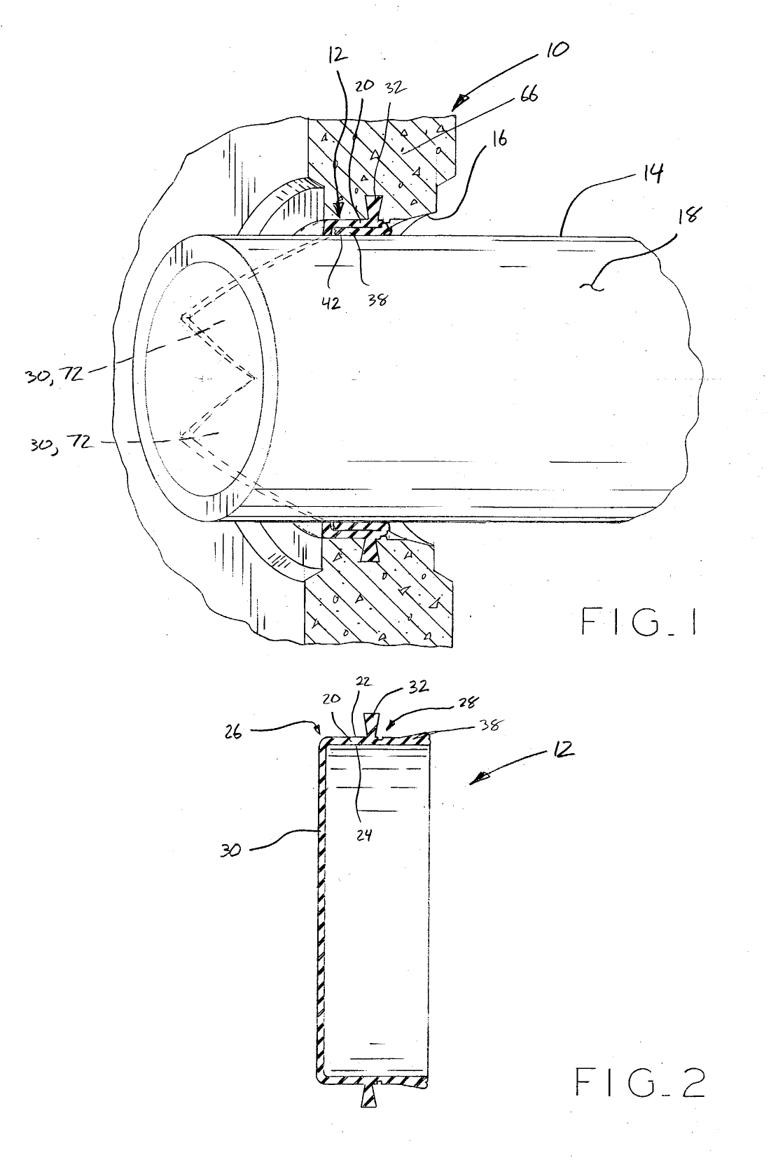

Referring to FIGS. 2 and 6, gasket or seal 12 includes an annular main body portion 20 having exterior surface 22 and interior surface 24. Body portion 20 also includes a first end 26 and a second end 28. First end 26 defines a closed end face, specifically, first end 26 is closed by a wall 30 which extends across first end 26 of body portion 20. Second end 28 defines an annular open end face of gasket 12.

Extending substantially perpendicularly from exterior surface 22 of body portion 20 of gasket 12 is anchoring projection 32. Anchoring projection 32 extends radially outwardly around the circumference of gasket 12 and, as best shown in FIG. 6, includes neck portion 34 and end portion 36. Anchoring projection 32 has a tapered profile, wherein the thickness of anchoring projection 32 at neck portion 34 is less than that at end portion 36 to provide a locking engagement with structure 10, as described further below.

Sealing projection 38 is attached to main body portion 20 of gasket by hinge 40, and is movable between a first stable position shown in solid lines in FIG. 6 and a second stable position shown in dashed lines in FIG. 6. Sealing projection 38 has a tapered profile in section, including enlarged end 42 distal of body 20 of gasket 12, which increases in thickness in an outward direction from hinge 40. Hinge 40 is formed as an annular notch, providing a hinge point about which sealing projection 38 may be manually folded. Specifically, in the first stable position, sealing projection 38 extends longitudinally outwardly from second end 28 of body portion 20 of gasket 12. In this first position, shown in solid lines in FIG. 6, sealing projection 38 is stable, such that sealing projection 38 will remain in such position in the absence of external forces applied thereto. Sealing projection 38 is foldable about hinge 40 to its second stable position, shown in dashed lines in FIG. 6, in which sealing projection 38 is disposed inwardly of body portion 20 of gasket 12 and adjacent interior surface 24 of body portion 20. Sealing projection 38 is also stable in its second position, such that sealing projection 38 will remain in such position in the absence of external forces applied thereto.

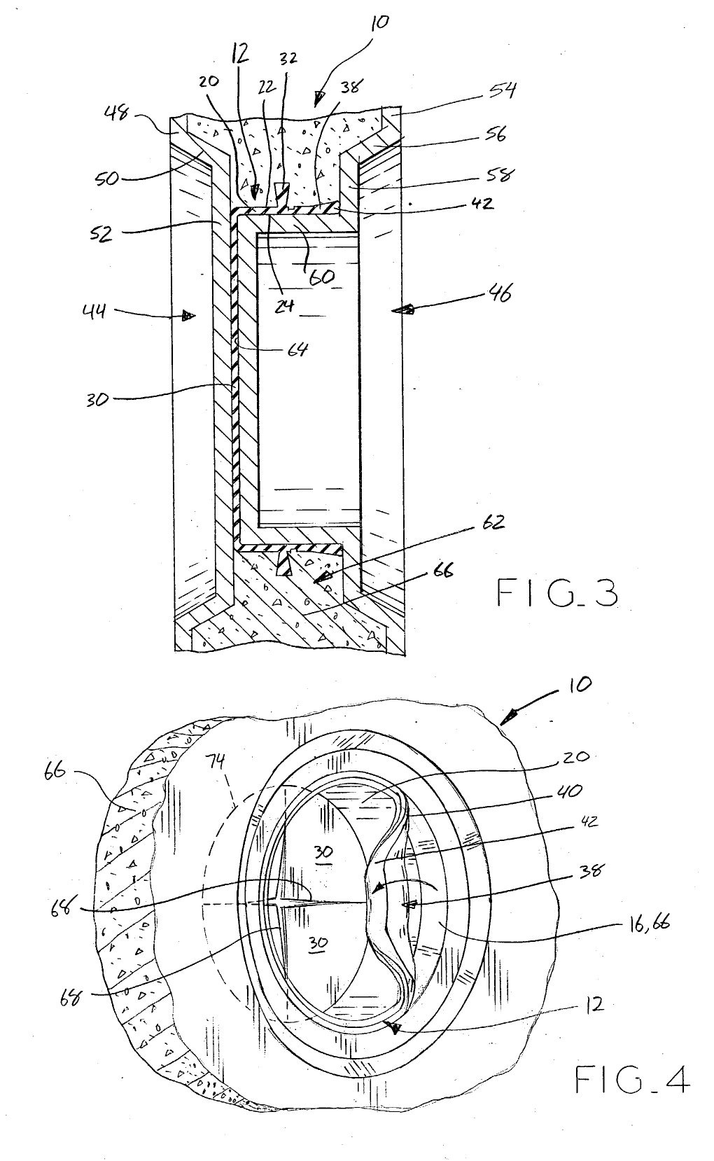

Gasket 12 may be formed from a suitable elastomeric material such as isoprene, for example, which is flexible and compressible. Gasket 12 may be formed by compression molding, wherein body portion 20, wall 30, anchoring projection 32, and sealing projection 38 are integrally formed in a single-step molding process. However, gasket 12 may also be formed by other suitable methods, and the foregoing portions of gasket 12 need not be integrally formed with one another. For example, body portion 20, anchoring projection 32, and sealing projection 38 of gasket 12 may be integrally formed by an extrusion process, wherein a length of extrusion is cut and the ends thereof joined by vulcanization or adhesive, for example, to form the annular portion of gasket 12. Then, wall 30 may be joined to body portion 20 of gasket 12 by a separate process. Other methods by which gasket 12 may be formed will be apparent to those skilled in the art. Referring to FIG. 3, gasket 12 is mounted within concrete structure 10 using a pair of forms 44 and 46, which isolate exterior surface 22 of body portion 20, anchoring projection 32, and the external surface of sealing projection 38 of gasket 12, and prevent concrete from contacting the internal surfaces and wall 30 of gasket 12. Form 44 includes main wall portion 48 having transition portion 50 and inner wall portion 52. Inner wall portion 52 is in abutting contact with the outer surface of wall 30 of gasket 12 when assembled. Form 46 includes main wall portion 54 and transition portion 56 between wall portion 54 and inner wall portion 58. Extending inwardly from inner wall portion 58 is core 60, which is substantially cup-shaped and engages the interior surface 24 of body portion 20 of gasket 12, the interior surface of wall 30, and the interior surface of sealing projection 38. The portions of forms 44 and 46 which are not in contact with gasket 12 define an area 62 for receiving concrete 66 to form structure 10.

In assembly of forms 44 and 46 with gasket 12, gasket 12 is placed over core 60 of form 46 until wall 30 of gasket 12 is in abutting contact with surface 64 of core 60 and enlarged end 42 of sealing projection 38 of gasket 12 is in contact with inner wall portion 58 of form 46. The engagement between enlarged end 42 and inner wall portion 58 prevents material from lodging therebetween or flowing into any space between core 60 and the inner surface of sealing projection 38. Assembly of gasket 12 onto core 60 is relatively easy with sealing projection 38 in its first stable position. Form 44 is then positioned with inner wall portion 50 thereof in abutting contact with the outer surface of wall 30.

After gasket 12 is assembled with forms 44 and 46, concrete 66 or another suitable material is poured into area 62, filling area 62 around the outer surface of gasket 12. Concrete 66 surrounds anchoring projection 32 of gasket 12 to permanently embed anchoring projection 32 within concrete 66 and lock gasket 12 in position within opening 16 formed in concrete structure 10. Specifically, the portion of concrete 66 around the tapered neck portion 34 (FIG. 6) of anchoring projection 32 acts to lock gasket 12 in place, preventing removal of gasket 12 from concrete structure 10, as end portion 36 (FIG. 6) of anchoring projection 32 is too thick to pass through the opening defined by the concrete around neck portion 34 of anchoring projection 32. Forms 44 and 46 are removed after concrete 66 sets up and hardens, with gasket 12 remaining in position in concrete structure 10. Sealing projection 38 remains in its first stable position until a user manually folds same inwardly to its second stable position, and described below. In this manner, sealing projection 38 is protected from damage during shipping or handling or the concrete structure 10.

When a user is ready to install pipe 14 to concrete structure 10, sealing projection 38 is pried away from concrete structure 10 and manually folded inwardly to its second stable position, as shown in FIG. 4. As there is no interlocking connection between enlarged end 42 of sealing projection 38 and concrete 66, the user may pull sealing projection 38 away from concrete 66. If necessary, a tool such as a screwdriver, for example, may be inserted between enlarged end 42 of sealing projection 38 and concrete 66 to facilitate in disengaging sealing projection 38 from concrete 66. As shown in FIG. 4, sealing projection 38 is then grasped and manually folded about hinge 40 from its first stable position to its second stable position.

Either before or after sealing projection 38 is folded from its first stable position to its second stable position, wall 30 is penetrated to create a pipe opening therethrough. Specifically, as shown in FIG. 4, wall 30 may be cut by making one or more slits at 68 with a suitable sharp tool to create a pipe opening through wall 30, such that pipe 14 may extend therethrough. Alternatively, wall 30 may be cut about the entire perimeter or circumference thereof along line 74, as shown in FIG. 4, then removed from the remainder of gasket 12 and discarded.

Notably, if there is no need to connect pipe 14 to the particular opening 16 in concrete structure 10 in which a gasket 12 is installed, the wall 30 of that gasket 12 is left intact. Advantageously therefore, in applications in which gasket 12 is not being used for a pipe joint, wall 30 of gasket 12 eliminates the need for a separate end cap to be attached to gasket 12 for closing opening 16, as in known gaskets. The thickness of wall 30 is sufficient to withstand internal pressures within structure 10, as well as external pressures from without structure 10, such as from surrounding soil and/or water. For example, wall may have a thickness of between about 0.06 inches and about 0.1 inches or more, depending upon the particular application in which gasket 12 is used. The thickness of wall 30 may be selected as desired for the particular application in which gasket 12 is used to provide suitable pressure resistance while also facilitating easy cutting or removal of wall 30. As discussed above, when gasket 12 is being used for a pipe joint, wall 30 may be simply slit or cut away from the remainder of gasket 12 to create a pipe opening to allow pipe 14 to pass through gasket 12.

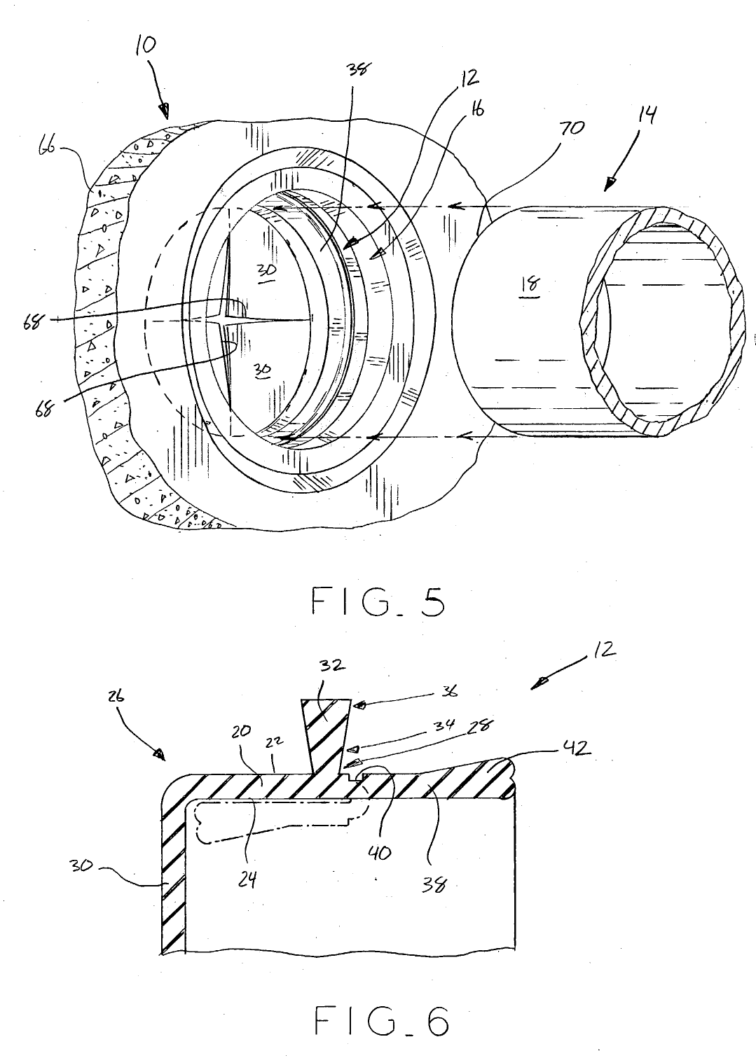

As shown in FIGS. 1 and 5, after sealing projection 38 of gasket 12 is folded to its second stable position, end 70 of pipe 14 is forced through gasket 12. Contact between outer surface 18 of pipe 14 and sealing projection 38 radially compresses sealing projection 38 of gasket 12 against body portion of gasket 12, as shown in FIG. 1. In turn, body portion 20 of gasket 12 is compressed between sealing projection 38 and the wall of opening 16 of structure 10. Enlarged end 42 of sealing projection 38 is compressed to a greater extent than the remainder of sealing projection 38 as pipe 14 is inserted through gasket 12 due to the increased thickness of enlarged end 42, thereby creating a fluid tight, compressive seal between gasket 12 and pipe 14. When pipe 14 is inserted through gasket 12, triangular shaped portions 72 of wall 30, which are formed by slits 68 in wall 30, extend outwardly from gasket 12 and are in abutting contact with the exterior surface 18 of pipe 14.

The diameter of pipe 14 may vary slightly with the pipe diameter not being exactly equal to the nominal inner diameter of gasket 12. For example, if the diameter of pipe 14 is slightly less than the nominal inner diameter of gasket 12, the above-described radial compression of sealing projection 38 of gasket 12 may be somewhat lessened while still providing a fluid tight joint between gasket 12 and pipe 14. Alternatively, if the diameter of pipe 14 is slightly greater than the nominal inner diameter of gasket 12, above-described radial compression of sealing projection 38 of gasket 12 is increased to provide a more robust fluid tight joint between gasket 12 and pipe 14. Further, the fluid tight seal which is formed by compression of sealing projection 38 of gasket 12 by direct contact between pipe 14 and body 20 of gasket 12 eliminates the need for separate clamping bands, which are necessary to provide a seal between pipe 14 and many known gaskets.

As an alternative to the above, gasket 12 may lack anchoring projection 32, wherein such gasket is installed within a pre-formed opening in a structure using an expansion band assembly, for example, to compress the body of the gasket into sealing engagement with the wall of the opening.

Further, the first and second positions of sealing projection 38 of gasket 12, shown in solid and in dashed lines in FIG. 6, respectively, need not necessarily be stable. For example, after sealing projection 38 of gasket 12 is folded inwardly to its second position, sealing projection 38 could be manually or otherwise held in that position until pipe 14 is inserted through gasket 12 to compress sealing projection 38 between pipe 14 and body 20 of gasket.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A gasket, comprising:
an annular body having a first end, an opposite second end, an exterior surface, and an interior surface;
a wall portion extending across and closing said first end of said annular body;
an annular sealing projection connected to said second end of said body, said sealing projection movable between a first position in which said sealing projection extends outwardly from said body and a second position in which said sealing projection is disposed within said body and is compressible against said body.

2. The gasket of claim 1, wherein said sealing projection is stable in at least one of said first and said second positions, whereby said sealing projection remains in its position in the absence of external forces applied thereto.

3. The gasket of claim 1, further comprising an anchoring projection extending radially from said exterior surface of said body.

4. The gasket of claim 1, wherein said sealing projection extends substantially longitudinally from said body in said first position.

5. The gasket of claim 1, whereby a pipe may be inserted through said wall portion upon making one or more slits in said wall portion.

6. The gasket of claim 1, whereby a pipe may be inserted through said body upon removing said wall portion from said body.

7. The gasket of claim 1, wherein said gasket is made of an elastomeric material, with said body, said wall portion, and said sealing projection integrally formed with one another.

8. The gasket of claim 1, further comprising an annular hinge portion connecting said body and said sealing projection, said sealing projection foldable about said hinge portion between said first and second positions.

9. The gasket of claim 1, wherein said sealing projection includes an enlarged end portion distal from said body.

10. A gasket for providing a seal between a pipe and a circular opening in a structure, said gasket comprising:
an annular body having a first end, an opposite second end, an exterior surface, and an interior surface;
means extending across said first end of said body for alternatively closing said first end of said body or providing an opening through said first end of said body;
an annular sealing projection connected to said second end of said body, said sealing projection movable between a first position in which said sealing projection extends outwardly of said body and a second position in which said sealing projection is disposed within said body and adjacent said interior surface of said body;
whereby said sealing projection in said second position is compressible against said annular body upon insertion of a pipe through said opening.

11. The gasket of claim 10, wherein said sealing projection is stable in at least one of said first and said second positions, whereby said sealing projection remains in its position in the absence of external forces applied thereto.

12. The gasket of claim 10, further comprising an anchoring projection extending radially from said exterior surface of said body.

13. The gasket of claim 10, wherein said gasket is made of an elastomeric material with said body and said sealing projection integrally formed with one another.

14. The gasket of claim 10, wherein said sealing projection increases in thickness from said body to an end portion of said sealing projection.

15. In combination:
a structure having a wall with a circular opening therein; and
a gasket installed within said opening, said gasket comprising:
an annular body having a first end, an opposite second end, an exterior surface, and an interior surface;
a wall portion closing said first end of said annular body, said wall portion selectively penetrable to provide a pipe opening therethough;
an annular sealing projection connected to said second end of said body, said sealing projection movable between a first position in which said sealing projection extends outwardly from said body and a second position in which said sealing projection is disposed within said body; whereby said sealing projection is compressible against said body in said second position upon insertion of a pipe through said pipe opening.

16. The combination of claim 15, wherein said sealing projection is stable in at least one of said first and said second positions, whereby said sealing projection remains in its position in the absence of external forces applied thereto.

17. The combination of claim 15, wherein said gasket further comprises an anchoring projection extending radially from said exterior surface of said body, said anchoring projection embedded within said wall.

18. The combination of claim 17, wherein said gasket is made of an elastomeric material with said body, said sealing projection, and said anchoring projection integrally formed with one another.

19. The combination of claim 15, whereby said pipe opening is formed by making one or more slits in said wall portion.

20. The combination of claim 15, whereby said pipe opening is formed by removing said wall portion from said body.

21. A method of providing a seal between a pipe and a structure, comprising the steps of:
installing a body of a gasket within an opening in the structure;
cutting a closed face of the gasket to form an opening through the gasket;
folding a sealing projection of the gasket from a first position in which the sealing projection extends substantially longitudinally away from the body of the gasket to a second position in which the sealing projection is disposed within the body of the gasket; and
inserting a pipe through the opening to compress the sealing projection between the pipe and the body of the gasket.

22. The method of claim 21, wherein said cutting step comprises making at least one cut substantially across the closed face of the gasket.

23. The method of claim 21, wherein said cutting step further comprises removing the closed face of the gasket from the body of the gasket.

24. The method of claim 21, wherein said folding step is carried out prior to said cutting step.
